(19) United States
(12) Patent Application Publication
(10) Pub. No.: US 2018/0216900 A1
(43) Pub. Date: Aug. 2, 2018

(54) ZONED CHILLER COILS FOR AIR INTAKE HOUSE OF GAS TURBINE

(71) Applicant: Braden Manufacturing, LLC, Tulsa, OK (US)

(72) Inventors: Laquinnia Lawson, JR., Tulsa, OK (US); Sanjay Mahapatra, Tulsa, OK (US)

(21) Appl. No.: 15/420,326

(22) Filed: Jan. 31, 2017

(51) Int. Cl. F28F 13/14; F28D 7/00; F28D 7/08; F02C 7/04; F02C 7/141

(52) U.S. Cl. CPC F28F 13/14; F28D 7/0058; F28D 2021/0026; F02C 7/04; F02C 7/141; F28D 7/082

(57) ABSTRACT

A chiller coil system for an air intake system of a combustion gas turbine system includes an array of chiller cooler modules. The chiller coil system includes at least one first chiller coil and at least one second chiller coil. The first chiller coil has a first overall thermal conductance. The second chiller coil has a second overall thermal conductance greater than the first overall thermal conductance.

### FIELD OF THE INVENTION

The present invention generally relates to zoned chiller coils for an air intake house of a gas turbine.

### BACKGROUND

Some intake air systems for combustion gas turbines of a power system include an inlet air cooling system for the purpose of increasing the air mass flow rate into the turbine compressor and power output of the system. One type of inlet air cooling system is a chiller coil system. A chiller coil system is typically associated with an air inlet filter house of the gas turbine system and includes a plurality of chiller coils housed in modules. Each chiller coil includes tubes as primary heat transfer area through which a relatively cold fluid media, such as water or a mixture of water and glycol, is passed. The tubes are equipped with fins that form the secondary heat transfer area. Hot and humid air passing through the air inlet filter house flows across the chiller coils heat transfer areas a, thereby cooling and dehumidifying the air. The cooled air exits the chiller coils with higher mass density and consequently higher mass flow rate for the same volumetric flow rate and is delivered to the gas turbine to increase combustion and mixture gas flow rate and turbine power output.

In one conventional chiller coil system, the chiller coils are substantially identical to one another. Therefore, the chiller coils in a conventional chiller coil system are of the same design and configuration, and have substantially the same overall thermal conductance. Although these conventional chiller coil systems work quite well for their intended purpose of increasing the air mass flow rate and power output, for at least some intake air systems where the cross-sectional air velocity distribution of the air intake system is non-uniform, the conventional chiller coil systems may not produce a uniform cross-sectional dry bulb and dew point temperature distribution of cooled air delivered to the gas turbine. Accordingly, this conventional chiller coil system produces regions of air dry bulb and dew point temperatures and mass density that are above or below the allowable desired variances of respective air temperatures and mass density delivered to a gas turbine compressor. Large variances in the above parameters may cause a multitude of material and performance issues that are detrimental to the overall life of the gas turbine compressor while not meeting the targeted or guaranteed power output for which the inlet chiller system was designed.

The information contained in this Background section is provided solely for the purpose of background information for the present disclosure. Applicant does not concede that the entirety of the information contained in this Background section was disclosed in the prior art or was otherwise publically available as of the filing date of the present application.

### SUMMARY OF THE DISCLOSURE

In one aspect, a chiller coil system for an air intake system of a combustion gas turbine system generally comprises an array of chiller coolers housed in modules. The chiller cooler system includes at least one first chiller coil and at least one second chiller coil. The first chiller coil has a first overall thermal conductance. The second chiller coil has a second overall thermal conductance greater than the first overall thermal conductance.

In another aspect, a combustion gas turbine system comprises an air inlet house defining an interior for receiving air from outside the gas turbine system and delivering air along an air flow path toward the compressor of the gas turbine system. At least one air filter is disposed in the air inlet house for filtering air flowing in the air inlet house toward the compressor of the gas turbine system. An array of chiller coils are in fluid communication with the air inlet house for cooling and dehumidifying air flowing in the air intake system toward the compressor of the gas turbine system. The array of chiller coils includes first and second chiller coils. The first chiller coil has a first overall thermal conductance, and the second chiller coil has a second overall thermal conductance greater than the first overall thermal conductance.

In yet another aspect, a method of zoning a chiller coil system for a combustion gas turbine system including an air intake system defining an air flow path generally comprises: determining a cross-sectional air velocity distribution at a cross-sectional area of the air flow path defined by the air intake system, wherein the air inlet velocity distribution includes first air velocities at first cross-sectional locations and a second air velocities greater than the first air velocities at second cross-sectional locations; and arranging at least one first chiller coil and at least one second chiller coil in the air intake system as an array of chiller coils based on the locations of the respective first and second air velocities, wherein said at least one first chiller coil is positioned in the array at locations generally corresponding to the first locations of the first air velocities, and said at least one second chiller coil is positioned in the array at locations generally corresponding to the second locations of the second air velocities.

Other features will be in part apparent and in part pointed out hereinafter.

### BRIEF DESCRIPTION OF THE DRAWINGS

FIG. 1 is a perspective of a combustion gas turbine system;

FIG. 2 is a perspective of an air intake system of the gas turbine system of FIG. 1, the air intake system including a chiller coil system;

FIG. 3 is a schematic of the chiller coil system; and

FIG. 4 is a simulated cross-sectional air velocity distribution for the air intake system computed using computational fluid dynamics (CFD) software.

Corresponding reference characters indicate corresponding parts throughout the drawings.

### DETAILED DESCRIPTION OF THE DISCLOSURE

The present disclosure relates to an improved chiller coil system for a combustion gas turbine system of a power system. The chiller coil system is associated with an air intake system of the combustion gas turbine system. In particular, the chiller coil system is contained inside an inlet air filter house of the air intake system. The chiller coil system may be downstream or upstream of air filters in the air filter house, although typically the chiller coil is downstream of the air filters and upstream of ducting (i.e., an inlet duct and plenum) leading to the compressor of the gas turbine. The chiller coil system comprises an array of chiller coils including at least one first chiller coil and at least one second chiller coil. The first chiller coil has a first overall thermal conductance, while the second chiller coil has a second overall thermal conductance that is greater than the first overall thermal conductance of the first chiller coil. The chiller coils are selectively arranged or positioned in zones within the array of chiller coils based on the cross-sectional air velocity distribution at the upstream face of the array within the air intake system. The designs of the chiller coils may be selectively tailored based on the cross-sectional air velocity distribution at the upstream face of the array within the air intake system to cool and dehumidify the air to a desired dry bulb and dew point temperatures, such that the air exiting the array has a substantially uniform cross-sectional temperature distribution.

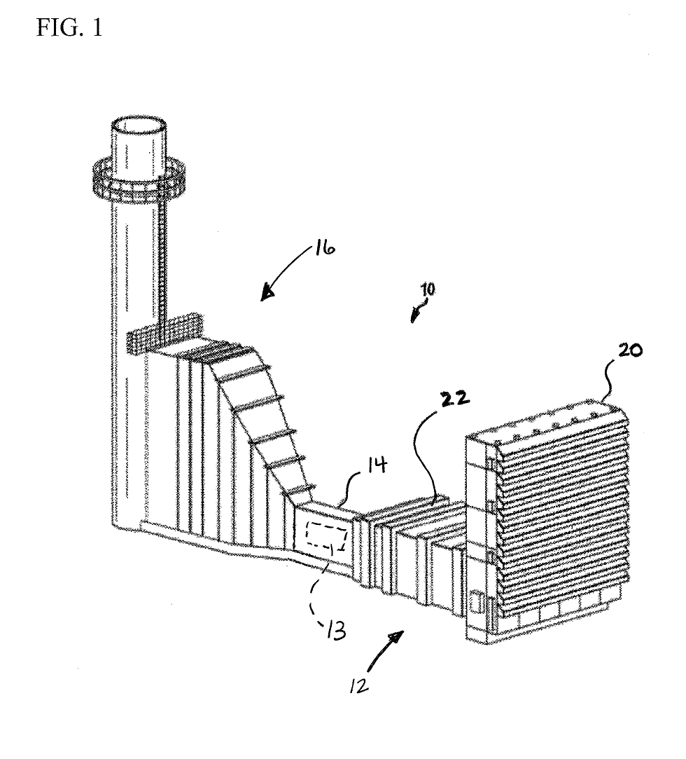

Referring to FIG. 1, one embodiment of a gas turbine system is generally indicated at reference numeral 10. As is generally known in the art, the gas turbine system 10 includes an air intake system, generally indicated at 12, upstream from a gas turbine engine 13 housed within a turbine housing 14. Although not shown, one of ordinary skill would understand that the gas turbine engine 13 includes a gas turbine compressor, which provides suction for pulling air through the air intake system 12 and into the gas turbine engine. Downstream of the gas turbine engine 13 is one embodiment of an exhaust gas system, generally indicated 16, the purpose and structure of which is known to those of ordinary skill and will not be described herein. In the illustrated embodiment, the air intake system 12 includes an air filter house 20 and an air intake duct or plenum 22 downstream of the air filter house and in fluid communication with the gas turbine 13. The air filter house 20 defines an interior for receiving air from outside the gas turbine system 10 and delivering air along an air flow path toward the gas turbine engine 13.

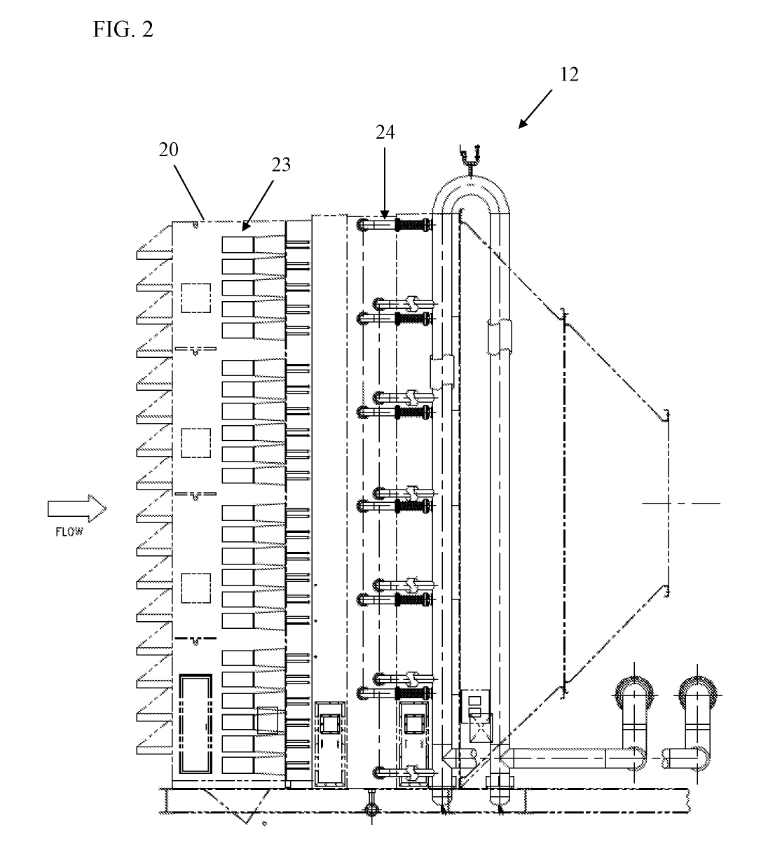

Referring to FIG. 2, an air filter system, generally indicated at 23, for ambient or atmospheric air flowing in the air filter house 20, and a chiller coil system, generally indicated at 24, is housed within the air filter house 20. The air filter system 23 includes at least one air filter (e.g., a plurality of air filters). In the illustrated embodiment, the chiller coil system 24 is located downstream from the air filter system 23. In other embodiments, the chiller coil system 24 may be located upstream from the air filter system 23. In yet other embodiments, the chiller coil system 24 may be disposed outside (e.g., secured to) the air inlet filter house 20 and in fluid communication therewith.

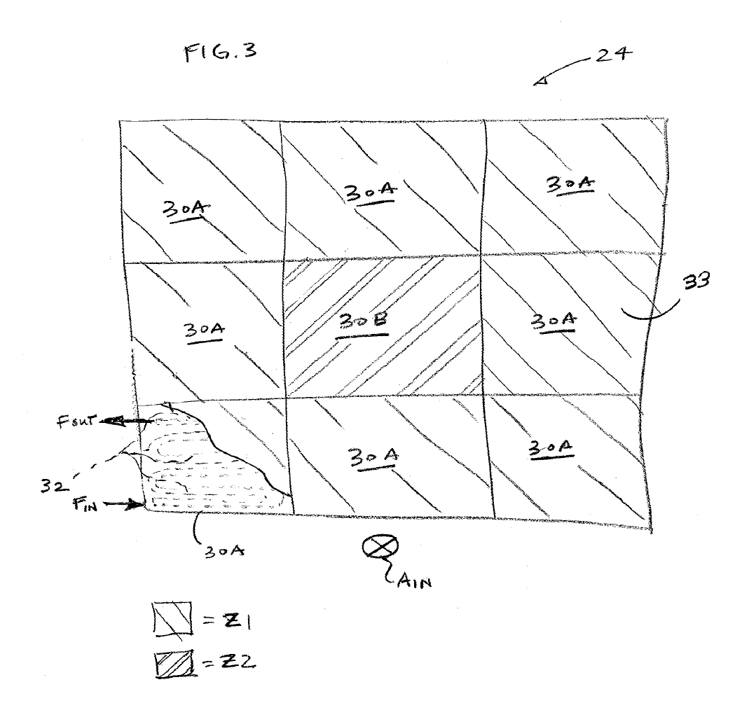

Referring to FIG. 3, the chiller coil system 24 comprises an array of first and second chiller coils 30A, 30B (the array being indicated generally by reference numeral 24, the same reference numeral indicating the chiller coil system). In the illustrated embodiment, the chiller coils 30A, 30B are arranged in three side-by-side vertical stacks of three modules to form a 3×3 array of modules. The chiller coil system 24 may be arranged in any suitable manner and include any suitable number of modules. As is generally known in the art, each chiller coil 30A, 30B includes spaced apart rows of horizontal tubes 32 as primary heat transfer surface (the rows are spaced apart from one another in the air flow direction), and a plurality of fins as secondary heat transfer surface (not shown) in thermal contact with the tubes. (The tubes 32 of a single chiller coil 30A are shown in FIG. 3 for illustrative purposes, with the understanding that the other chiller coils also include heat transfer tubes.) Each row of tubes includes a plurality of heat transfer tubes 32 spaced apart vertically from one another. The heat transfer tubes 32 are fluidly connected to one another within groups (i.e., circuits) and may be arranged in generally serpentine shape in the horizontal direction within the group. Each chiller coil 30A, 30B may have one or more dedicated inlets for receiving the cooling fluid (as indicated by arrow F_{IN}) and one or more dedicated outlets through which the cooling fluid flows out of the coil after heat transfer (as indicated by arrow F_{OUT}). (In FIG. 3, a single chiller coil is shown with the flow of cooling fluid indicated by arrows F_{IN} and F_{OUT}, with the understanding that the other chiller coils also include this flow of cooling fluid.) A supply of cooling fluid (not shown) may be connected to the inlet of each chiller coil 30A, 30B, such that the temperature and flow rate of the cooling fluid entering the individual modules are substantially the same (i.e., the temperature and flow rate of the cooling fluid entering the chiller coil system 24 is substantially uniform.) The chiller coils 30A, 30B may be of other designs or types for facilitating heat transfer to cool a gas (e.g., air) without departing from the scope of the present invention.

As is generally known, the overall heat transfer by each chiller coil 30A, 30B is defined by the following equation:

$$Q = \frac{UoAo ( TDo - TDi )}{ln ( TDo / TDi )}$$

where Uo is the overall coefficient of heat transfer, Ao is the area based on the outside area of the primary heat transfer surface, and TD=Tₕ−T_{c} at the inlet (i) and outlet (o) conditions, respectively. The U value is mainly defined by the design of the chiller coils and the materials used in its construction of tubes and fins, velocity and temperatures of the cooling fluid and intake air. For example, the U-value of the chiller coil 30A, 30B may be based, at least in part, on the following parameters of the module: the number of rows of heat transfer tubes (e.g., number of tubes in direction of air flow), the number of heat transfer tubes per serpentine row face pitch and row pitch of the heat transfer tubes, circuiting of the heat transfer tubes (e.g., single circuit, dual circuit, interlaced, the fin density (i.e., fins per inch of heat transfer tube length), and the fin type (flat or spiral, etc. The product of U and A (i.e., UA) defines the overall thermal conductance of the chiller coil. The temperature term (TDₒ−TDᵢ)/ln(TDₒ/TDᵢ) is called the logarithmic mean temperature difference (LMTD).

Referring still to FIG. 3, the first chiller coil 30A has a first U-value U1 and a first area A1 defining a first overall thermal conductance TC1 (i.e., the product of U1 and A1), and a second chiller coil 30B has a second U-value U2 and a second area A1 defining a second overall thermal conductance TC2 (i.e., the product of U2 and A2) that is greater than the first overall thermal conductance TC1 of the first chiller coil. As used herein, the first chiller coil is referred to as a “lower thermal conductance chiller coil,” and the second chiller is referred to as a “higher thermal conductance chiller coil,” with the understanding that the terms “low thermal conductance” and “high thermal conductance” are meant to be relative terms. In one embodiment, at least the U-value U2 of the second chiller coil 30B is greater than the U-value U1 of the first chiller coil 30A to make the second overall thermal conductance TC2 greater than the first overall thermal conductance TC1 of the first chiller coil. Moreover, in the illustrated embodiment, the chiller coils 30A, 30B may have the different logarithmic mean temperature difference (LMTD) during operation with the temperature and flow rate of the cooling fluid being substantially uniform throughout the array, as disclosed above. Moreover still, during operation and for reasons explained below, the second chiller coil 30B has a second overall heat transfer Q2 that is greater than a first overall heat transfer Q1 of the first chiller coil 30A.

In one example, the U-value U2 of the second chiller coil 30B is greater than the U-value U1 of the first chiller coil 30A, the area A2 of the second chiller coil is equal to the area A1 of the first chiller coil, and the logarithmic mean temperature difference (LMTD) of the first and second chiller coils are equal. Accordingly, in this example, the U-values U1, U2, respectively, are the determining variables or parameters of the first and second chiller coils 30A, 30B, respectively, for making the second overall thermal conductance TC2 of the second chiller coil greater than the first overall thermal conductance T1 of the first chiller coil. In one embodiment, one or more of the following parameters of the second chiller coil 30B may be different than the corresponding parameters of the first chiller coil 30A, such that the U-value U2 is greater than the U-value U1: the number of rows of heat transfer tubes in the direction of air flow the number of fluid passes, face pitch and row pitch of the heat transfer tubes, circuiting of the heat transfer tubes (e.g., single circuit, dual circuit, interlaced, face split, etc.), the fin density (i.e., fins per inch of heat transfer tube length), and the fin type (flat or spiral). It is generally known in the art how each of the above parameters affect the U-value of a chiller coil. For example, increasing one or more of the number of rows of heat transfer tubes 32, the fin density, and fluid flow rate will increase the U-value of a chiller coil.

In other examples, the U-value U2 of the second chiller coil 30B may be greater than the U-value U1 of the first chiller coil 30A, the area A2 of the second chiller coil may be greater than (or less than) the area A1 of the first chiller coil, and the logarithmic mean temperature difference (LMTD) of the second chiller coil may be greater than (or less than) the logarithmic mean temperature difference (LMTD) of the second chiller coil, with the second overall thermal conductance TC2 of the second chiller coil being greater than the first overall thermal conductance TC1 of the first chiller coil. In yet other examples, the U-value U2 of the second chiller coil 30B may be equal to (or less than) the U-value U1 of the first chiller coil 30A, the area A2 of the second chiller coil may be greater than the area A1 of the first chiller coil, and the logarithmic mean temperature difference (LMTD) of the second chiller coil may be greater than, less than, or equal to the logarithmic mean temperature difference (LMTD) of the second chiller coil, with the second overall thermal conductance TC2 and the overall heat transfer of the second chiller coil being greater than the first overall thermal conductance TC1 and the overall heat transfer of the first chiller coil, respectively.

As show in FIG. 3, the chiller coils 30A, 30B are positioned in corresponding, predetermined first and second “zones” Z1, Z2, respectively, within the chiller coil array 24. The locations of the zones Z1, Z2 are based on a cross-sectional air velocity distribution at the upstream face 33 of the chiller coil array. The term “cross-sectional” means generally transverse to the air flow path (indicated by arrow A_{IN}) defined by the air intake system 12. In the illustrated embodiment, the first zone(s) Z1 represents the location(s) where the air velocities are about equal to a first velocity or within a range of first velocities. The second zone(s) Z2 represents the location(s) where the air velocities are about equal to a second velocity greater than the first velocity, or within a range of second velocities greater than the range of first velocities. The low thermal conductance chiller coil(s) 30A (which also has relatively low overall heat transfer) is positioned in the first zone(s) Z1 of the chiller coil array 24, and the high thermal conductance chiller coil(s) 30B (which also have relatively high overall heat transfer) is positioned in second zone(s) Z2 of the chiller coil array. Thus, the low thermal conductance chiller coil(s) 30A are positioned in location(s) where the air velocity is relatively low, and the high thermal conductance chiller coil(s) 30B are positioned in location(s) where the air velocity is relatively high. Through this arrangement, as can be understood by one in the art, the chiller coil array 24 is configured to produce a cross-sectional temperature distribution of cooled air exiting the array that is more uniform than a cross-sectional temperature of the cooled air exiting a conventional array that includes chiller coils having the same overall thermal conductance and overall heat capacities.

In the illustrated embodiment, there are eight (8) low thermal conductance chiller coils 30A adjacent to and extending around the perimeter of the chiller coil array 24, and one (1) high thermal conductance chiller coil at the center of the array. It is understood that the cooling media array 30 may include any number of different types of chiller coils have thermal conductance greater than or equal to first and second thermal conductance TC1, TC2 of the respective first and second chiller coils 30A, 30B, and positioned in the chiller coil array 24 based on cross-sectional locations or zone(s).

Each chiller coil (e.g., each of the first and second chiller coils 30A, 30B) may be configured (e.g., designed and manufactured) to have an overall thermal conductance and overall heat transfer generally tailored to the zone in which it is positioned in the air intake system 12 so that the array 24 is capable of producing a cross-sectional temperature distribution of cooled air exiting the array that is more uniform than a cross-sectional temperature of cooled air exiting a conventional array that includes chiller coils having the same overall thermal conductance and the same overall heat transfer. In one example, each chiller coil 30A, 30B is tailored such that the chiller coil array 24 is capable of producing a substantially uniform cross-sectional temperature distribution of cooled air exiting the array. As explained in more detail below, one or more of the following factors may also play a role when designing each chiller coil to have a tailored thermal conductance and overall heat transfer: i) cooling the air to a desired temperature (e.g., 50° F.), achieving condensation to a desired maximum or within a desired range (e.g., minimizing condensation), and achieving a pressure drop to a desired maximum or within a desired range (e.g., minimizing pressure drop).

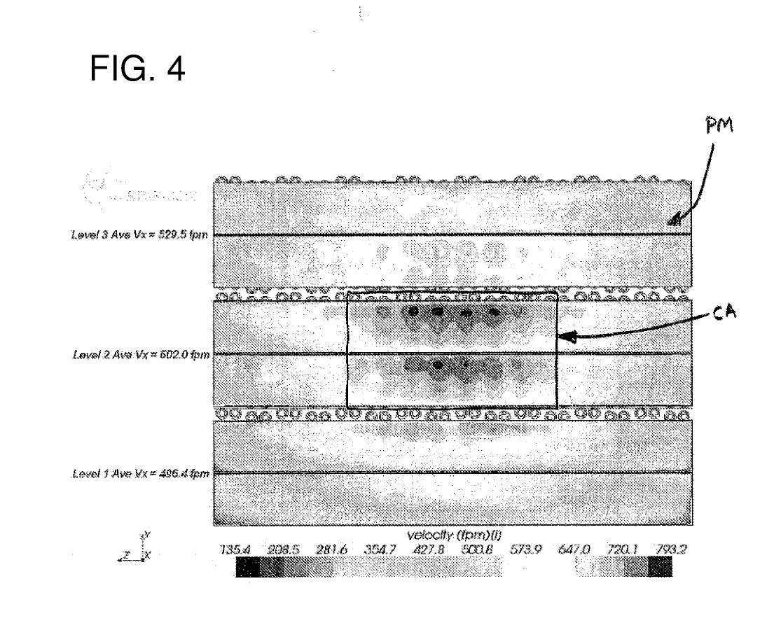

In a method of zoning a chiller coil system 24, the cross-sectional air velocity distribution of an air intake system 12 may be determined by computer simulation. One example of a simulated cross-sectional air velocity distribution at the upstream face 33 of the chiller coil array is illustrated in FIG. 4. The simulated cross-sectional air velocity distribution was computed using computational fluid dynamics (CFD) software, such as STAR-CCM-+® software available from CD-adapco, Melville, N.Y.). The chiller coils 30A, 30B shown in FIG. 3 are arranged in the air intake system 12 based on the simulated cross-sectional air velocity distribution of FIG. 4. As can be generally seen from the simulated cross-sectional air velocity distribution in FIG. 4, air velocities increase toward the center of the upstream face 33 of the chiller coil array 24, such that the lower air velocities are generally adjacent a perimeter margin PM of the chiller coil array and the greater air velocities are generally adjacent a central area CA of the cooling media array. It is understood that air intake systems of other gas turbine systems may have other cross-sectional air velocity distributions. In general, the cross-sectional air velocity distribution of the air intake system 12 is based, at least in part, on the suction profile of the gas turbine compressor and the design and geometry of the intake filter system 20, particularly the intake plenum. For example, some air intake system of a particular gas turbine system may have an air inlet velocity distribution where the highest air velocities are adjacent a left or right side margin or a top or bottom margin, as opposed to being located at a central area.

Using the cross-sectional air velocity distribution of the particular air intake system 12, the chiller coil array 24 can be designed and constructed with chiller coils 30A, 30B having desired thermal conductance, such as chiller coils that are specifically designed or tailored to the particular air intake system based on the cross-sectional air velocity distribution to achieve uniform temperature distribution of air exiting the chiller coil array. For example, the air inlet velocity distribution in FIG. 4 has a high concentration of relatively high air velocities at the central area CA, and most of the air velocities outside the central area, within the perimeter margin PM, are relatively low air velocities. Based on this information, the chiller coil array illustrated in FIG. 3 is arranged so that one high thermal conductance chiller coil 30B is positioned within the zone Z1 (e.g., a central zone), and a plurality of low thermal conductance chiller coils 30A are positioned within the zone Z2 (e.g., a peripheral zone), outside the central zone. In particular, the high thermal conductance chiller coils 30B may be tailored for cooling air having a velocity from about 700 fpm to about 800 fpm a desired temperature (e.g., 50° F.), and the low thermal conductance chiller coils 30A may be tailored for cooling air having a velocity from about 500 fpm to about 650 fpm to the same desired temperature (e.g., 50° F.). As can be understood, there may be any suitable number of chiller coils tailored for any number of zones based on the air velocity distribution of a particular air intake system for producing a more uniform (e.g., a substantially uniform) air temperature distribution of cooled air exiting the module array.

In one example, using the simulated cross-sectional air velocity distribution, the desired overall thermal conductance TC1, TC2 of the modules 30A, 30B are determined (e.g., calculated) using simulation software, for example, in order to achieve the desired cooling of the air flow. The areas A1, A2 and the logarithmic mean temperature differences (LMTD) are also factors to consider when tailoring the overall thermal conductance TC1, TC2 of the modules 30A, 30B, although both the areas and the logarithmic mean temperature difference (LMTD) may be the same for all of the modules in the array 24. In other words, the modules 30A, 30B may be tailored to have a desired overall thermal conductance TC1, TC2 by changing the respective U-values (i.e., the U-values may be variables, while the areas and the logarithmic mean temperature differences (LMTD) may be constants). Typically, one or more of the following parameters of the chiller coil(s) 30A, 30B are the variables for modifying or tailoring the chiller coils based on the simulated cross-sectional air velocity distribution of the air intake system: the number of rows of heat transfer tubes (e.g., number of tubes in direction of air flow), the number of heat transfer tubes per serpentine row face pitch and row pitch of the heat transfer tubes, circuiting of the heat transfer tubes (e.g., single circuit, dual circuit, interlaced, the fin density (i.e., fins per inch of heat transfer tube length), and the fin type (flat or spiral, etc.).

As set forth above, any number of different chiller coils 30A, 30B may be used in the chiller coil array 24. Moreover, although the perimeter shapes or footprints of the illustrated zones Z1, Z2 are generally rectilinear (e.g., rectangular) in the embodiment illustrated, the profiles of the zones may be circular, elliptical, or other shapes without departing from the scope of the present invention. Moreover, the chiller coil array 24 may have non-contiguous zones of the same cooling media type.

It is believed that the zoned chiller coil array 24 of different chiller coils 30A, 30B having different overall thermal conductance TC1, TC2 provides several advantages over chiller coil systems that have an array of the same chiller coils having the same overall thermal conductance. For example, the chiller coil system 24 including zoned chiller cooler modules 30A, 30B may have one or more of the following non-limiting advantages: a) uniform temperature distribution at the compressor intake; b) uniform air mixing; c) uniform velocity profile at the exit face of the evaporative cooling media; d) reduction in pressure drop due to lower shear forces between moving fluid flow layers of different densities, which also reduces the effect of fluid layering or lamination, e) reduction of under and over cooling of intake air; and f) reduction of water condensation.

Having described the invention in detail, it will be apparent that modifications and variations are possible without departing from the scope of the invention defined in the appended claims.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A chiller coil system for an air intake system of a combustion gas turbine system, the evaporative cooling system comprising:
an array of chiller cooler modules including at least one first chiller coil and at least one second chiller coil, the first chiller coil having a first overall thermal conductance, and the second chiller coil having a second overall thermal conductance greater than the first overall thermal conductance.

2. The chiller coil system set forth in claim 1, wherein said at least one first chiller coil is positioned in a first zone within the array, and wherein said at least one second chiller coil is positioned in a second zone within the array, wherein an estimated cross-sectional air velocity distribution at the second zone when the chiller coil system is installed in the air intake system is greater than an estimated cross-sectional air velocity distribution at the first zone when the chiller coil system is installed in the air intake system.

3. The chiller coil system set forth in claim 2, wherein the first zone comprises a perimeter zone adjacent a perimeter of the array, and wherein the second zone comprises a central zone generally in a center of the array.

4. The chiller coil system set forth in claim 1, wherein said at least one first and second chiller coils have substantially equal logarithmic mean temperature differences (LMTD) when operating.

5. The chiller coil system set forth in claim 1, wherein each of said at least one first and second chiller coils comprises a plurality of rows of heat transfer tubes configured to receive a cooling fluid therein, and a plurality of fins thermally connected to the heat transfer tubes.

6. The chiller coil system set forth in claim 5, wherein a density of the fins of said at least one first chiller coil is less than a density of the fins of said at least one second chiller coil.

7. The chiller coil system set forth in claim 5, wherein the number of rows of heat transfer tubes of said at least one first chiller coil is less than the number of rows of heat transfer tubes of said at least one second chiller coil.

8. An air intake system for a combustion gas turbine system including a gas turbine engine, the air inlet system comprising:
an air inlet house defining an interior for receiving air from outside the gas turbine system and delivering air along an air flow path toward the gas turbine engine;
at least one air filter disposed in the air inlet house for filtering air flowing in the air inlet house toward the gas turbine system;
an array of chiller coils in fluid communication with the air inlet house for cooling air flowing in the air intake system toward the gas turbine engine, the array of chiller coils including first and second chiller coils, the first chiller coil having a first overall thermal conductance, and the second chiller coil having a second overall thermal conductance greater than the first overall thermal conductance.

9. The air intake system set forth in claim 8, wherein the array of chiller coils is disposed in the air inlet house.

10. The air intake system set forth in claim 9, wherein the array of chiller coils is downstream from the at least one air filter.

11. The air intake system set forth in claim 8, wherein said at least one first chiller coil is positioned in a first zone within the array, and wherein said at least one second chiller coil is positioned in a second zone within the array, wherein a cross-sectional air velocity distribution at the second zone is greater than a cross-sectional air velocity distribution at the first zone.

12. The air intake system set forth in claim 11, wherein said at least one first and second chiller coils have substantially equal logarithmic mean temperature differences (LMTD) when operating.

13. The air intake system set forth in claim 8, wherein each of said at least one first and second chiller coils comprises a plurality of rows of heat transfer tubes configured to receive a cooling fluid therein, and a plurality of fins thermally connected to the heat transfer tubes.

14. The air intake system set forth in claim 13, wherein a density of the fins of said at least one first chiller coil is less than a density of the fins of said at least one second chiller coil.

15. The air intake system set forth in claim 13, wherein the number of rows of heat transfer tubes of said at least one first chiller coil is less than the number of rows of heat transfer tubes of said at least one second chiller coil.

16. A method of zoning a chiller coil system for a combustion gas turbine system including an air intake system defining an air flow path, the method comprising:
determining a cross-sectional air velocity distribution at a cross-sectional area of the air flow path defined by the air intake system, wherein the air inlet velocity distribution includes first air velocities at first cross-sectional locations and a second air velocities greater than the first air velocities at second cross-sectional locations;
arranging at least one first chiller coil and at least one second chiller coil in the air intake system as an array of chiller coils based on the locations of the respective first and second air velocities, wherein said at least one first chiller coil is positioned in the array at locations generally corresponding to the first locations of the first air velocities, and said at least one second chiller coil is positioned in the array at locations generally corresponding to the second locations of the second air velocities.

17. The method set forth in claim 16, wherein said determining a cross-sectional air velocity distribution comprises simulating the cross-sectional air velocity distribution using computational fluid dynamics software.

18. The method set forth in claim 16, wherein each of said at least one first and second chiller coils comprises a plurality of rows of heat transfer tubes configured to receive a cooling fluid therein, and a plurality of fins thermally connected to the heat transfer tubes.

19. The method set forth in claim 16, wherein a density of the fins of said at least one first chiller coil is less than a density of the fins of said at least one second chiller coil.

20. The method set forth in claim 16, wherein the number of rows of heat transfer tubes of said at least one first chiller coil is less than the number of rows of heat transfer tubes of said at least one second chiller coil.
